(19) United States
(12) Patent Application Publication
(10) Pub. No.: US 2011/0176837 A1
(43) Pub. Date: Jul. 21, 2011

(54) DEVELOPING APPARATUS AND IMAGE FORMING APPARATUS

(75) Inventor: Hiroshi Kawaguchi, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/009,202

(22) Filed: Jan. 19, 2011

Related U.S. Application Data
(60) Provisional application No. 61/296,975, filed on Jan. 21, 2010.

(51) Int. Cl. G03G 15/08

(52) U.S. Cl. 399/257

(57) ABSTRACT

According to one embodiment, a deteriorated carrier included in a developer circulating in a developer tank is extracted. The extracted deteriorated carrier is guided to an outflow port.

### CROSS-REFERENCE TO RELATED APPLICATIONS

This application is based upon and claims the benefit of priority from U.S. provisional application 61/296,975, filed on Jan. 21, 2010, the entire contents of which are incorporated herein by reference.

### FIELD

Embodiments described herein relate generally to a developing apparatus and an image forming apparatus.

### BACKGROUND

A developing apparatus uses a so-called two-component developer including a toner and a carrier. The developing apparatus agitates the toner and the carrier of the supplied developer, and gives an electric charge for developing an electrostatic latent image to the toner by friction charging based on this agitation. The toner is supplied to the surface of a photoconductive drum, and is consumed and decreased. The carrier is not consumed and remains in the developing apparatus. Thus, the carrier in the developing apparatus increases.

The carrier includes a particle made of a metal having magnetic properties, for example, ferrite, and a resin layer coated on the surface of the particle. The resin layer has a charging function. The resin layer is gradually peeled off by the agitation. The carrier in which the resin layer is peeled can not give a stable electric charge to the toner.

### DESCRIPTION OF THE DRAWINGS

FIG. 1 is a view showing a structure of an image forming apparatus of respective embodiments.

FIG. 2 is a view showing a structure of a developing apparatus of a first embodiment.

FIG. 3 is a view of a section along line A-A of FIG. 2 when viewed in an arrow direction.

FIG. 4 is a view showing a structure of a developer of the respective embodiments.

FIG. 5 is a view showing a first filter of the first embodiment.

FIG. 6 is a view showing a second filter of the first embodiment.

FIG. 7 is a block diagram of a control circuit of the first embodiment.

FIG. 8 is a view showing a modified example of the first filter of the first embodiment.

FIG. 9 is a view showing a modified example of the second filter of the first embodiment.

FIG. 10 is a view showing another modified example of the first filer of the first embodiment.

FIG. 11 is a view showing another modified example of the second filter of the first embodiment.

FIG. 12 is a view showing a structure of a developing apparatus of a second embodiment.

FIG. 13 is a view of a section along line B-B of

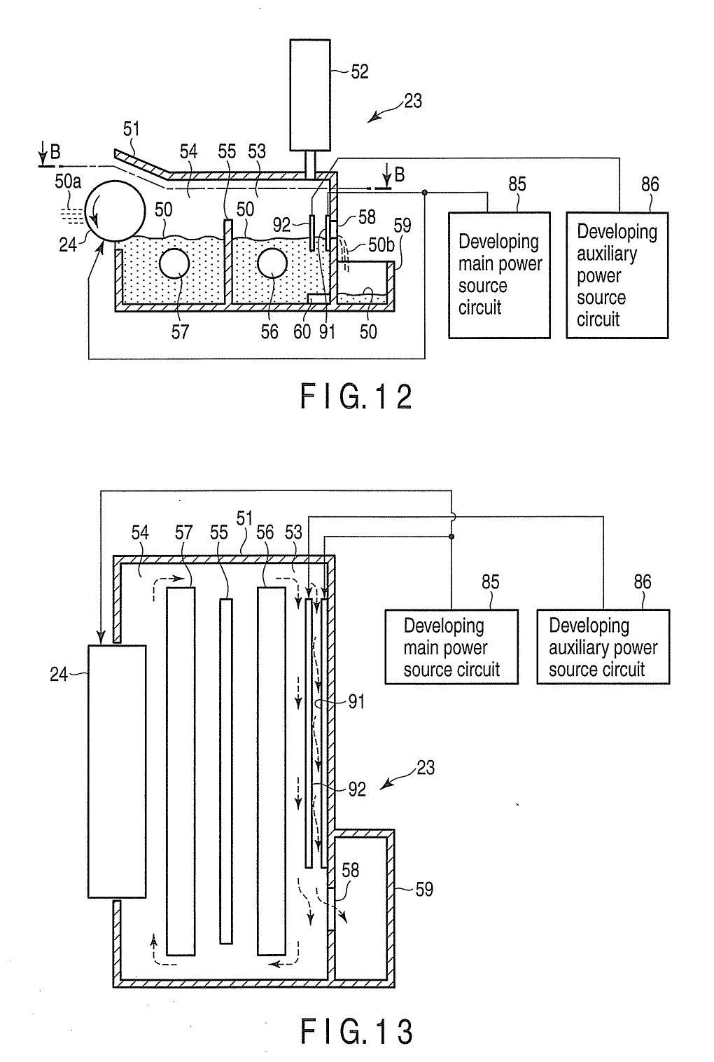

FIG. 12 when viewed in an arrow direction.

### DETAILED DESCRIPTION

In general, according to one embodiment, a developing apparatus includes:

a developer tank configured to contain a developer including a toner and a carrier and has an outflow port of the developer at a specified height position;

at least one mixer configured to agitate and circulate the developer in the developer tank;

a developing roller configured to supply the developer in the developer tank to an image carrier; and

a guide unit configured to extract and guide a deteriorated carrier included in the circulating developer to the outflow port.

[1] Hereinafter, a first embodiment of the invention will be described with reference to the drawings.

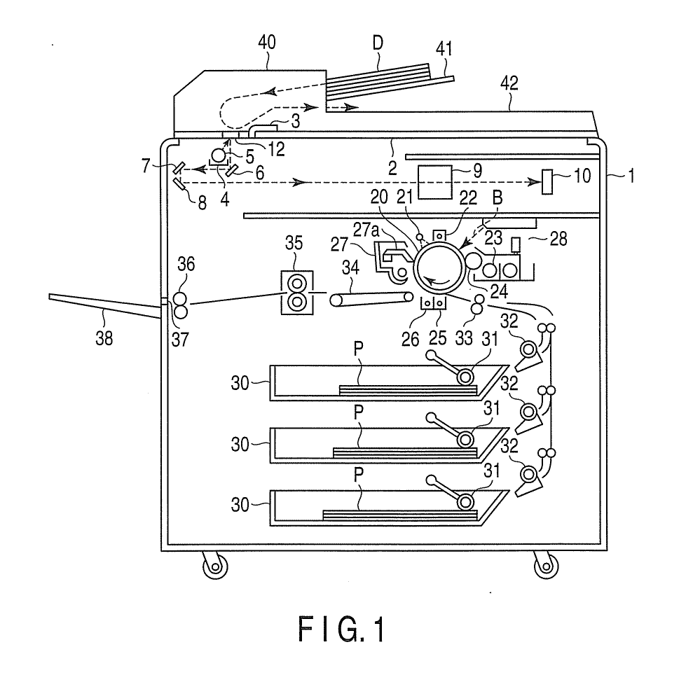

As shown in FIG. 1, a transparent document table (glass plate) 2 for placing a document is disposed at an upper part of a main body 1. An indicator 3 is disposed at one side part of the document table 2. A stepped part between the indicator 3 and the document table 2 is a reference position for document set.

A carriage 4 is disposed at a lower surface side of the document table 2. An exposure lamp 5 is disposed in the carriage 4. The carriage 4 can move (reciprocate) along the lower surface of the document table 2. The exposure lamp 5 is lit while the carriage 4 moves along the document table 2, so that the document placed on the document table 2 is exposed.

A reflected light image from the document is obtained by this exposure, and the reflected light image is projected onto a CCD (Charge Coupled Device) 10 by reflecting mirrors 6, 7 and 8 and a variable power lens block 9. The CCD 10 outputs an image signal corresponding to the projected image. The image signal outputted from the CCD 10 is converted into a digital signal, and the digital signal is supplied to an exposure unit 28. The exposure unit 28 emits a laser beam B corresponding to the input signal.

A window 12 for reading a document is disposed in the vicinity of the indicator 3. An auto document feeder (ADF) 40 serving also as a document cover is openably and closably disposed over the document table 2, the indicator 3 and the window 12. The auto document feeder 40 includes a tray 41 for placing a document, sends plural documents D set on the tray 41 one by one to the window 12, causes the sheet to pass through on the window 12, and discharges the passing documents D to a tray 42. When the auto document feeder 40 operates, the exposure lamp 5 emits a light at the position corresponding to the window 12, and the light is irradiated to the window 12. The light irradiated to the window 12 is irradiated to the document D on the window 12. The reflected light image from the document D is obtained by this irradiation, and the reflected light image is projected onto the CCD 10 by the reflecting mirrors 6, 7 and 8 and the variable power lens block 9.

On the other hand, a photoreceptor as a rotary image carrier, for example, a photoconductive drum 20 is disposed in the vicinity of the exposure unit 28. A charge removing unit 21, a charging unit 22, a developing unit 23, a transfer unit 25, a peeling unit 26 and a cleaning unit 27 are sequentially disposed around the photoconductive drum 20. The laser beam B emitted from the exposure unit 28 passes between the charging unit 22 and the developing unit 23, and is irradiated to the surface of the photoconductive drum 20.

The charge removing unit 21 irradiates light of a lamp or a light-emitting diode to the photoconductive drum 20, and removes (charge removal) an electric charge remaining on the surface of the photoconductive drum 20. The charging unit 22 applies a high voltage to the photoconductive drum 20 and gives an electrostatic charge to the surface of the photoconductive drum 20. The surface of the photoconductive drum 20 charged in this way is exposed to the laser beam B from the exposure unit 28, and an electrostatic latent image is formed on the surface of the photoconductive drum 20.

The developing unit 23 contains a developer (two-component developer) including a toner and a carrier, and gives the toner of the developer to the surface of the photoconductive drum 20 by a developing roller 24. By this, the electrostatic latent image on the surface of the photoconductive drum 20 is developed and becomes a visible image. The transfer unit 25 transfers the visible image on the surface of the photoconductive drum 20 to a paper sheet P supplied from an after-mentioned register roller 33. The peeling unit 26 peels the paper sheet P, which passes through the transfer unit 25, from the photoconductive drum 20. The cleaning unit 27 includes a blade 27a which contacts with the surface of the photoconductive drum 20, and removes toner or the like remaining on the surface of the photoconductive drum 20.

Incidentally, the photoconductive drum 20, the charge removing unit 21, the charging unit 22, the developing unit 23, the transfer unit 25, the peeling unit 26, the cleaning unit 27 and the exposure unit 28 constitute an integral process cartridge.

Plural sheet cassettes 30 are disposed at a lower part of the main body 1. The sheet cassettes 30 contain a number of paper sheets P having different sizes. Respective pickup rollers 31 take out the paper sheets P in the respective sheet cassettes 30 one by one. Respective separation rollers 32 send the paper sheets P taken out from the respective sheet cassettes 30 to the respective register rollers 33. The respective register rollers 33 feed the paper sheets P to between the photoconductive drum 20 and the transfer unit 25 at a timing in view of the rotation of the photoconductive drum 20.

A conveyance belt 34 sends the paper sheet P peeled from the photoconductive drum 20 to a fixing unit 35. The fixing unit 35 fixes a transfer image on the paper sheet P by heat. A paper discharge roller 36 discharges the paper sheet P subjected to fixing to a tray 38 through a discharge port 37.

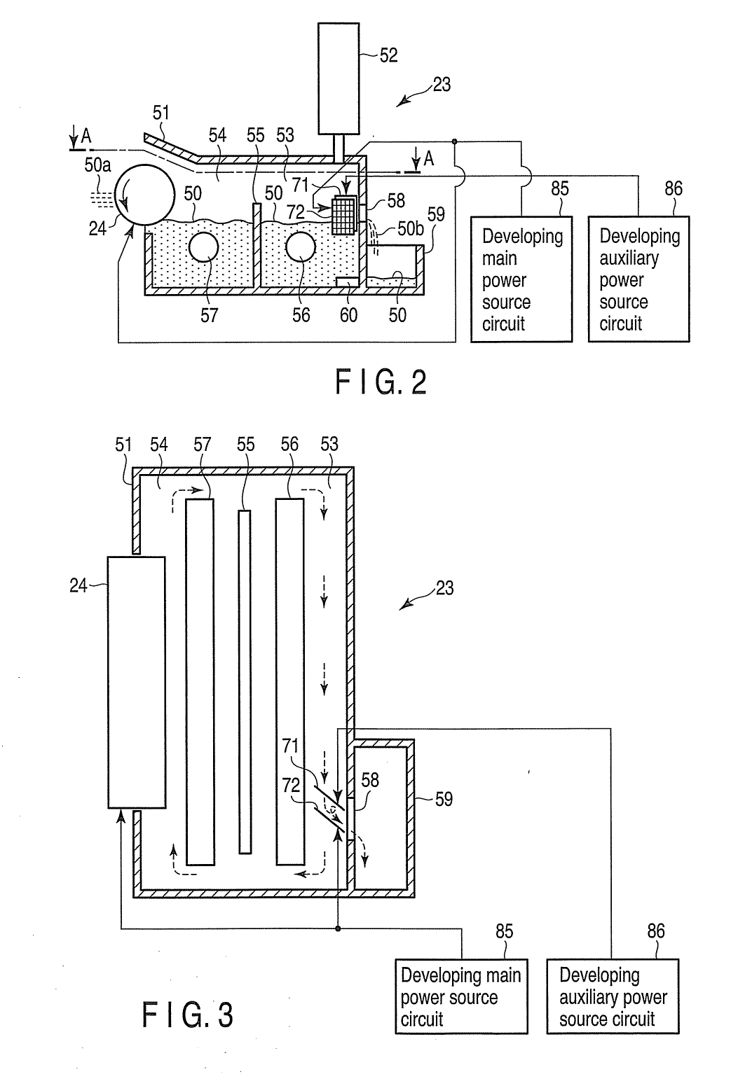

FIG. 2 and FIG. 3 show a specific structure of the developing unit 23. FIG. 3 is a view of a section along line A-A of FIG. 2 when viewed in an arrow direction.

The developing unit 23 includes a developer tank 51 to contain a developer 50 including a toner and a carrier, a detachable and attachable supply container 52 to supply the developer 50 to the developer tank 51, a partition plate 55 to partition the developer tank 51 into a supply side area 53 and a use side area 54, a mixer 56 to agitate and circulate the developer 50 in the supply side area 53 in a direction of a broken line arrow, a mixer 57 to agitate and circulate the developer 50 in the use side area 54 in a direction of a broken line arrow, an outflow port 58 formed at a specified height position in one side wall corresponding to the supply side area 53 among the respective side walls of the developer tank 51, a container 59 to contain the developer 50 flowing out from the outflow port 58, and a toner concentration sensor 60 to detect the concentration of the toner of the developer 50 in the developer tank 51.

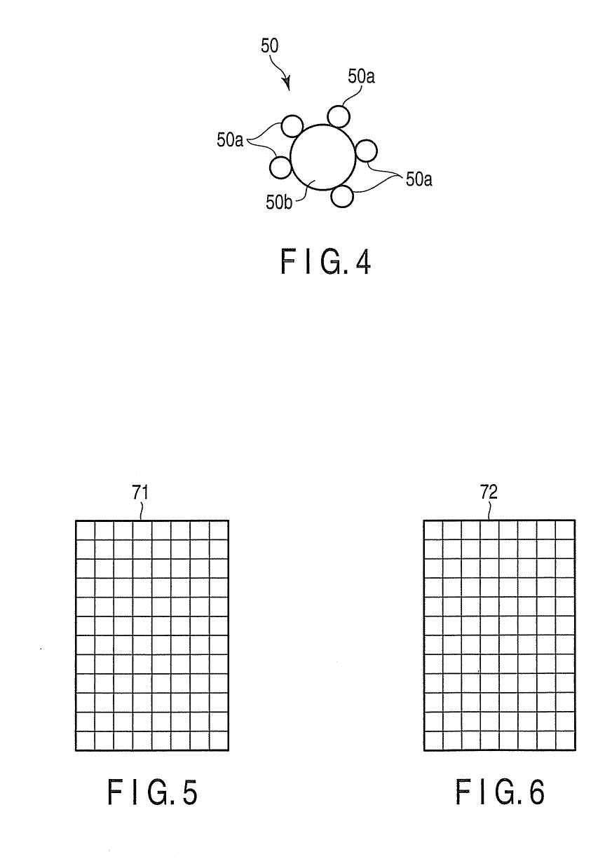

The toner of the developer 50 is an aggregate of toners 50a shown in FIG. 4. The carrier of the developer 50 is an aggregate of carriers 50b shown in FIG. 4. The carrier 50b includes a particle of a metal having magnetic properties, for example, ferrite and a resin layer coated on the surface of the particle. The resin layer has a charge function. The resin layer is gradually peeled off by the agitation of the mixers 56 and 57. The carrier 50b whose resin layer is peeled off can not give a stable electric charge to the toner 50a.

A filer (first filter) 71 for extracting deteriorated carrier and a filter (second filter) 72 for extracting deteriorated carrier, through which the developer 50 passes, are disposed in sequence in the vicinity of the outflow port 58 in the supply side area 53 of the developer tank 51 and along the circulating direction of the developer 50.

As shown in FIG. 5, the filter 71 is such that a conductive member is formed into a mesh shape, allows the circulating developer to pass through, and includes a first end part positioned at the outflow port 58 side and a second end part positioned at the opposite side to the outflow port 58. The position of the second end part is at the upstream side of the position of the first end part in the circulating direction of the developer.

As shown in FIG. 6, the filter 72 is such that a conductive member is formed into a mesh shape, allows the circulating developer to pass through, and includes a third end part positioned at the outflow port 58 side and a fourth end part positioned at the opposite side to the outflow port 58. The position of the fourth end part is at the upstream side of the position of the third end part in the circulating direction of the developer.

A developing main power source circuit (first power source circuit) 85 is connected to the filter 72. A developing auxiliary power source circuit (second power source circuit) 86 is connected to the filer 71. The developing main power source circuit 85 and the developing auxiliary power source circuit 86 constitute a power source unit for applying bias voltages to the respective filters 71 and 72. The power source unit and the filters 71 and 72 constitute a guide unit which extracts a deteriorated carrier included in the circulating developer and guides it to the outflow port 58.

The developing main power source circuit 85 outputs a developing bias voltage, for example, −500V to the developing roller 24. The developing bias voltage of −500V is directly applied to the filter 72. That is, the bias voltage having the same polarity and the same potential as the developing bias voltage applied to the developing roller 24 is applied to the filter 72. The developing auxiliary power source circuit 86 outputs a bias voltage having a polarity opposite to the bias voltage applied to the filter 72, for example, +10V. The bias voltage of +10V is applied to the filter 71.

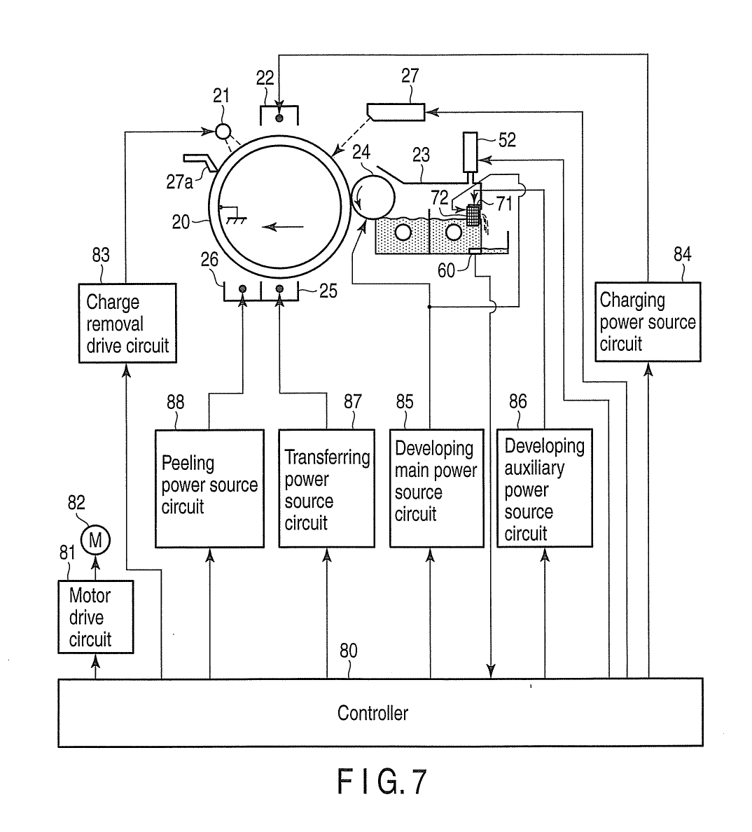

FIG. 7 shows a peripheral part of the photoconductive drum 20 and a control circuit.

A controller 80 controls the whole main body 1. The controller 80 is connected with a motor drive circuit 81, a charge removal drive circuit 83, a charging power source circuit 84, the developing main power source circuit 85, the developing auxiliary power source circuit 86, a transferring power source circuit 87, a peeling power source circuit 88 and the supply container 52.

The motor drive circuit 81 drives a motor 82 in response to instructions of the controller 80. The motor 82 drives the photoconductive drum 20 and drives a conveyance mechanism of the paper sheet P. The charge removal drive circuit 83 drives the charge removing unit 21 in response to instructions of the controller 80. The charging power source circuit 84 outputs a high voltage for charging. This output is supplied to the charging unit 22. The transferring power source circuit 87 outputs a high voltage for transfer. This output is supplied to the transfer unit 25. The peeling power source circuit 88 outputs a voltage for peeling. This output is supplied to the peeling unit 26.

The operation will be described.

The toner 50a of the developer in the developer tank 51 is supplied to the surface of the photoconductive drum 20, and is consumed and decreased. The carrier 50b of the developer in the developer tank 51 is not consumed and remains in the developer tank 51. When the toner concentration detected by the toner concentration sensor 60 is reduced to a set value or less, the controller 80 supplies a specific amount of developer 50 from the supply container 52 into the developer tank 51.

The developer 50 in the developer tank 51 is agitated by the mixers 56 and 57 and circulates in the direction of the broken line arrow of FIG. 3. The circulating developer 50 passes through the filers 71 and 72.

An electric field is generated between the filter 71 to which the bias voltage of +10V is applied and the filter 72 to which the bias voltage of −500V is applied.

In the developer 50 passing through the filters 71 and 72, the carrier 50b in which the resin layer is peeled off and the particle of ferrite is exposed, that is, the so-called deteriorated carrier 50b is reduced in electric resistance value and is susceptible to the influence of an electric field. The deteriorated carrier 50b susceptible to the influence of an electric field receives the influence of the electric filed between the filters 71 and 72, and floats and is retained between the filters 71 and 72. The floating and retained deteriorated carrier 50b receives the flow of the developer 50 newly flowing in between the filters 71 and 72, is attracted by the filter 72 to which the bias voltage of −500V is applied, and is guided to the outflow port 58 along the filter 72. The deteriorated carrier 50b guided to the outflow port 58 passes through the outflow port 58 and is contained in the container 59. The carrier 50b which is not deteriorated does not receive the influence of the electric field between the filters 71 and 72, and passes through the filters 71 and 72 without being guided to the outflow port 58.

As stated above, the deteriorated carrier 50b in the developer tank 51 is extracted and is guided to the outflow port 58, so that the amount of the deteriorated carrier 50b in the developer tank 51 can be reduced. Since the amount of the deteriorated carrier 50b in the developer tank 51 is decreased, the amount of the unused toner 50a and the non-deteriorated carrier 50b overflowing through the outflow port 58 can be decreased by the amount.

Since the amount of the deteriorated carrier 50b in the developer tank 51 is decreased, the electric charge required for the development can be stably given to the toner 50a. Thus, excellent development can always be performed.

Incidentally, the same effect can be obtained also in such a structure that while the developing bias voltage of −500V outputted from the developing main power source circuit 85 remains applied to the filter 72, a bias voltage of a ground potential (zero) is outputted from the developing auxiliary power source circuit 86, and the bias voltage of the ground potential (zero) is applied to the filter 71. Besides, the same effect can be obtained also in such a structure that while the developing bias voltage of −500V outputted from the developing main power source circuit 85 remains applied to the filter 72, a bias voltage having the same polarity as the developing bias voltage of −500V and lower than the developing bias voltage of −500V, for example, −100V is outputted from the developing auxiliary power source circuit 86, and the bias voltage of −100V is applied to the filter 71.

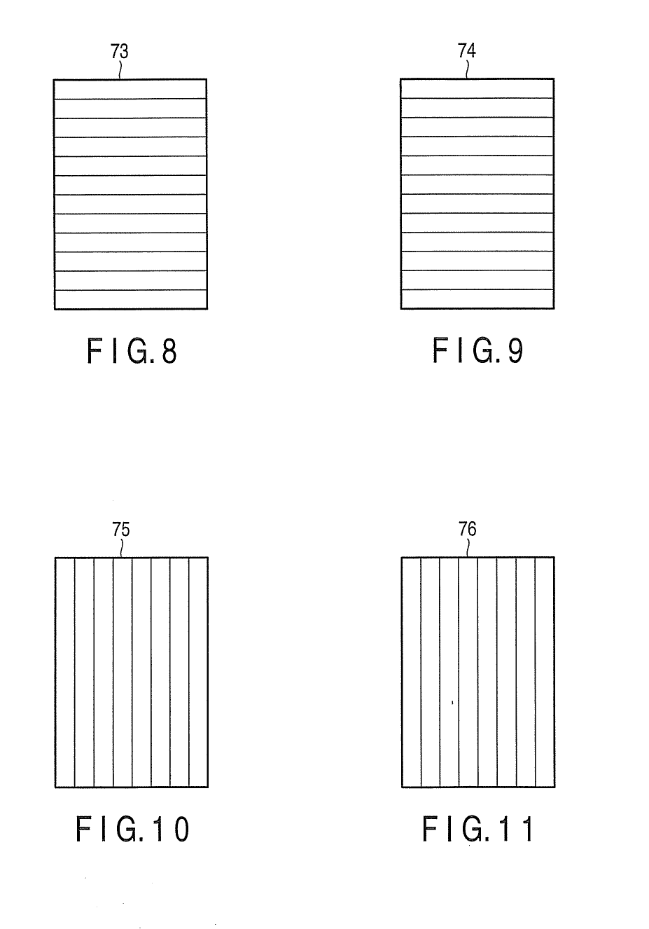

Besides, instead of the mesh-shaped filters 71 and 72, lateral blind-shaped filters 73 and 74 as shown in FIG. 8 and FIG. 9 may be used. Instead of the mesh-shaped filters 71 and 72, vertical blind-shaped filters 75 and 76 shown in FIG. 10 and FIG. 11 may be used. The lateral blind-shaped filter 73 and the vertical blind-shaped filter 76 may be combined and used.

FIG. 12 and FIG. 13 show a main part of a second embodiment. FIG. 13 is a view of a section along line B-B of FIG. 12 when viewed in an arrow direction.

A conductive plate member (first plate member) 91 is disposed at an upstream position of an outflow port 58 in the circulating direction of a developer 50 in a developer tank 51, along the circulating direction of the developer 50 and adjacently to an inner wall of the developer tank 51. Further, a conductive plate member (second plate member) 92 is disposed in the developer tank 51 and in parallel to the plate member 91.

A developing main power source circuit (first power source circuit) 85 is connected to the plate member 91. A developing auxiliary power source circuit (second power source circuit) 86 is connected to the plate member 92. The developing power source circuit 85 and the developing auxiliary power source circuit 86 constitute a power source unit for applying bias voltages to the respective plate members 91 and 92. The power source unit and the plate members 91 and 92 constitute a guide unit which extracts a deteriorated carrier included in the circulating developer and guides it to the outflow port 58.

The developing main power source circuit 85 outputs a developing bias voltage, for example, −500V to a developing roller 24. The developing bias voltage of −500V is directly applied to the plate member 91. That is, the bias voltage having the same polarity and the same potential as the developing bias voltage applied to the developing roller 24 is applied to the plate member 91. The developing auxiliary power source circuit 86 outputs a bias voltage having a polarity opposite to the bias voltage applied to the plate member 91, for example, +10V. The bias voltage of +10V is applied to the plate member 92.

The operation will be described.

An electric field is generated between the plate member 91 to which the bias voltage of −500V is applied and the plate member 92 to which the bias voltage of +10V is applied.

A part of the developer 50 circulating through the supply side area 53 in the developer tank 51 flows in between the plate members 91 and 92. The developer 50 flowing in between the plate members 91 and 92 includes a carrier 50b, so-called deteriorated carrier 50b in which a resin layer is peeled off and a particle of ferrite is exposed. The deteriorated carrier 50b is reduced in electric resistance value and is susceptible to the influence of an electric field.

Besides, in the developer 50 flowing from the use side area 54 to the supply side area 53 in the developer tank 51, the deteriorated carrier 50b susceptible to the influence of an electric field is easily attracted to between the plate members 91 and 92.

The deteriorated carrier 50b included in the developer 50 flowing in between the plate members 91 and 92 and the deteriorated carrier 50b attracted to between the plate members 91 and 92 receive the influence of the electric field between the plate members 91 and 92, and float between the plate members 91 and 92. The floating deteriorated carrier 50b receives the flow of the developer 50 newly flowing in between the plate members 91 and 92, is attracted by the plate member 91 to which the bias voltage of −500V is applied, and flows along the plate member 91. The deteriorated carrier 50b flowing along the plate member 91 receives the flow of the developer 50 which passes through between the plate members 91 and 92, receives the pressure from the developer 50 which flows along the outside of the plate member 92 and expands to the outflow port 58 side, and is pushed out to the outside of the outflow port 58.

As stated above, the deteriorated carrier 50b in the developer tank 51 is extracted and is guided to the outflow port 58, so that the amount of the deteriorated carrier 50b in the developer tank 51 can be reduced. Since the amount of the deteriorated carrier 50b in the developer tank 51 is reduced, the amount of the unused toner 50a and the non-deteriorated carrier 50b overflowing from the outflow port 58 can be reduced by the amount.

Since the amount of the deteriorated carrier 50b in the developer tank 51 is reduced, the electric charge required for development can be stably applied to the toner 50a. Thus, excellent development can always be performed.

Incidentally, the same effect can be obtained also in such a structure that while the developing bias voltage of −500V outputted from the developing main power source circuit 85 remains applied to the plate member 91, a bias voltage of a ground potential (zero) is outputted from the developing auxiliary power source circuit 86, and the bias voltage of the ground potential (zero) is applied to the plate member 92. Besides, the same effect can be obtained also in such a structure that while the developing bias voltage of −500V outputted from the developing main power source circuit 85 remains applied to the plate member 91, a bias voltage having the same polarity as the developing bias voltage of −500V and lower than the developing bias voltage of −500V, for example, −100V is outputted from the developing auxiliary power source circuit 86, and the bias voltage of −100V is applied to the plate member 92.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and sprit of the inventions.

What is claimed is:

1. A developing apparatus comprising:
a developer tank configured to contain a developer including a toner and a carrier and has an outflow port of the developer at a specified height position;
at least one mixer configured to agitate and circulate the developer in the developer tank;
a developing roller configured to supply the developer agitated by the mixer to an image carrier; and
a guide unit configured to extract and guide a deteriorated carrier included in the circulating developer to the outflow port.

2. The apparatus of claim 1, wherein
the guide unit includes:
a first and a second filter for deteriorated carrier extraction disposed in sequence in a vicinity of the outflow port in the developer tank and along a circulating direction of the developer; and
a power source unit configured to apply bias voltages to the first and the second filter.

3. The apparatus of claim 2, wherein
the power source unit includes:
a first power source circuit configured to apply a bias voltage, which has a same polarity as a developing bias voltage applied to the developing roller, to the second filter; and
a second power source circuit configured to apply a bias voltage, which has a polarity opposite to the bias voltage applied to the second filter from the first power source circuit, to the first filter.

4. The apparatus of claim 2, wherein
the power source unit includes:
a first power source circuit configured to apply a bias voltage, which has a same polarity as a developing bias voltage applied to the developing roller, to the second filter; and
a second power source circuit configured to apply a bias voltage of a ground potential to the first filter.

5. The apparatus of claim 2, wherein
the power source unit includes:
a first power source circuit configured to apply a bias voltage, which has a same polarity as a developing bias voltage applied to the developing roller, to the second filter; and
a second power source circuit configured to apply a bias voltage, which has a same polarity as the bias voltage applied to the second filter from the first power source circuit and is lower than the bias voltage applied to the second filter, to the first filter.

6. The apparatus of claim 2, wherein
the first filter has one of a mesh shape and a blind shape through which the circulating developer passes, includes a first end part positioned at the outflow port side and a second end part positioned at an opposite side to the outflow port, and a position of the second end part is at an upstream side of a position of the first end part in the circulating direction of the developer, and
the second filter has one of a mesh shape and a blind shape through which the circulating developer passes, includes a third end part positioned at the outflow port side and a fourth end part positioned at an opposite side to the outflow port, and a position of the fourth end part is at an upstream side of a position of the third end part in the circulating direction of the developer.

7. The apparatus of claim 6, wherein
the power source unit includes:
a first power source circuit configured to apply a bias voltage, which has a same polarity as a developing bias voltage applied to the developing roller, to the second filter; and
a second power source circuit configured to apply a bias voltage, which has a polarity opposite to the bias voltage applied to the second filter from the first power source circuit, to the first filter.

8. The apparatus of claim 6, wherein
the power source unit includes:
a first power source circuit configured to apply a bias voltage, which has a same polarity as a developing bias voltage applied to the developing roller, to the second filter; and
a second power source circuit configured to apply a bias voltage of a ground potential to the first filter.

9. The apparatus of claim 6, wherein
the power source unit includes:
a first power source circuit configured to apply a bias voltage, which has a same polarity as a developing bias voltage applied to the developing roller, to the second filter; and
a second power source circuit configured to apply a bias voltage, which has a same polarity as the bias voltage applied to the second filter from the first power source circuit and is lower than the bias voltage applied to the second filter, to the first filter.

10. The apparatus of claim 2, wherein
the guide unit includes:
a first plate member that is disposed at an upstream position of the outflow port in the circulating direction of the developer in the developer tank and along the circulating direction of the developer;
a second plate member disposed in parallel to the first plate member in the developer tank; and
a power source unit configured to apply bias voltages to the first plate member and the second plate member.

11. The apparatus of claim 10, wherein
the power source unit includes:
a first power source circuit configured to apply a bias voltage, which has a same polarity as a developing bias voltage applied to the developing roller, to the second plate member; and
a second power source circuit configured to apply a bias voltage, which has a polarity opposite to the bias voltage applied to the second plate member from the first power source circuit, to the first plate member.

12. The apparatus of claim 10, wherein
the power source unit includes:
a first power source circuit configured to apply a bias voltage, which has a same polarity as a developing bias voltage applied to the developing roller, to the second plate member; and
a second power source circuit configured to apply a bias voltage of a ground potential to the first plate member.

13. The apparatus of claim 10, wherein
the power source unit includes:
a first power source circuit configured to apply a bias voltage, which has a same polarity as a developing bias voltage applied to the developing roller, to the second plate member; and
a second power source circuit configured to apply a bias voltage, which has a same polarity as the bias voltage applied to the second plate member from the first power source circuit and is lower than the bias voltage applied to the second plate member, to the first plate member.

14. An image forming apparatus comprising;
a photoreceptor;
a charge removing unit configured to remove an electric charge on a surface of the photoreceptor;
a charging unit configured to charge the surface of the photoreceptor whose electric charge is removed by the charge removing unit;
an exposure unit to expose the surface of the photoreceptor charged by the charging unit; and
a developing unit including a developer tank configured to contain a developer having a toner and a carrier and has an outflow port of the developer at a specified height position, at least one mixer configured to agitate and circulate the developer in the developer tank, a developing roller configured to supply the developer agitated by the mixer to the photoreceptor, and a guide unit configured to extract and guide a deteriorated carrier included in the circulating developer to the outflow port.

15. The apparatus of claim 14, wherein
the guide unit includes:
a first and a second filter for deteriorated carrier extraction disposed in sequence in a vicinity of the outflow port in the developer tank and along a circulating direction of the developer; and
a power source unit configured to apply bias voltages to the first and the second filter.

16. The apparatus of claim 15, wherein
the power source unit includes:
a first power source circuit configured to apply a bias voltage, which has a same polarity as a developing bias voltage applied to the developing roller, to the second filter; and
a second power source circuit configured to apply a bias voltage, which has a polarity opposite to the bias voltage applied to the second filter from the first power source circuit, to the first filter.

17. The apparatus of claim 15, wherein
the power source unit includes:
a first power source circuit configured to apply a bias voltage, which has a same polarity as a developing bias voltage applied to the developing roller, to the second filter; and
a second power source circuit configured to apply a bias voltage of a ground potential to the first filter.

18. The apparatus of claim 15, wherein
the power source unit includes:
a first power source circuit configured to apply a bias voltage, which has a same polarity as a developing bias voltage applied to the developing roller, to the second filter; and
a second power source circuit configured to apply a bias voltage, which has a same polarity as the bias voltage applied to the second filter from the first power source circuit and is lower than the bias voltage applied to the second filter, to the first filter.

19. The apparatus of claim 15, wherein
the first filter has one of a mesh shape and a blind shape through which the circulating developer passes, includes a first end part positioned at the outflow port side and a second end part positioned at an opposite side to the outflow port, and a position of the second end part is at an upstream side of a position of the first end part in the circulating direction of the developer, and
the second filter has one of a mesh shape and a blind shape through which the circulating developer passes, includes a third end part positioned at the outflow port side and a fourth end part positioned at an opposite side to the outflow port, and a position of the fourth end part is at an upstream side of a position of the third end part in the circulating direction of the developer.

20. The apparatus of claim 14, wherein
the guide unit includes:
a first plate member that is disposed at an upstream position of the outflow port in the circulating direction of the developer in the developer tank and along the circulating direction of the developer;
a second plate member disposed in parallel to the first plate member in the developer tank; and
a power source unit configured to apply bias voltages to the first plate member and the second plate member.
